(19) United States
(12) Patent Application Publication
(10) Pub. No.: US 2016/0224053 A1
(43) Pub. Date: Aug. 4, 2016

(54) TIMER-BASED PROCESSING UNIT OPERATIONAL SCALING EMPLOYING TIMER RESETTING ON IDLE PROCESS SCHEDULING

(71) Applicant: QUALCOMM Incorporated, San Diego, CA (US)

(72) Inventors: Narasimha Rao Koramutla, San Diego, CA (US); Gurudeep Bhat, San Diego, CA (US); Aneeket Patil, San Diego, CA (US)

(21) Appl. No.: 14/851,155

(22) Filed: Sep. 11, 2015

Related U.S. Application Data
(60) Provisional application No. 62/109,809, filed on Jan. 30, 2015.

(51) Int. Cl. G06F 1/08; G06F 9/48; G06F 13/24

(52) U.S. Cl. CPC G06F 1/08; G06F 13/24; G06F 9/4825

(57) ABSTRACT

Timer-based processing unit operational scaling employing timer resetting on idle process scheduling is disclosed. In one aspect, a timer controls scheduling of a processing unit utilization process to perform operational scaling of a processing unit. The timer expiration triggers an interrupt to schedule the processing unit utilization process to scale operational performance. To avoid the need for frequent execution of the processing unit utilization process, the processing unit is first configured to determine if an idle process is scheduled for execution at timer expiration before interrupt generation. If the idle process is scheduled, this is an inherent indication that the processing unit is not over-utilized, because otherwise, the idle process would not be scheduled. If the idle process is scheduled, the interrupt to schedule the processing unit utilization process is not generated, and the timer is reset.

### PRIORITY APPLICATION

This application claims priority under 35 U.S.C. §119(e) to U.S. Provisional Patent Application No. 62/109,809 filed Jan. 30, 2015 and entitled “DYNAMIC, TIMER-BASED PROCESSING UNIT OPERATIONAL SCALING SYSTEMS EMPLOYING TIMER RESETTING ON IDLE THREAD SCHEDULING, TO INCREASE OPERATIONAL SCALING RESPONSE TIMES WITH REDUCED IMPACT ON PROCESSING UNIT PERFORMANCE,” which is incorporated herein by reference in its entirety.

### BACKGROUND

I. Field of the Disclosure

The technology of the disclosure relates generally to processing unit performance, and more particularly to operational scaling of a processing unit to support processing unit performance requirements.

II. Background

Synchronous digital circuits, such as central processing units (CPUs) or digital signal processors (DSPs) as examples, use a clock signal to coordinate timing of logic in the circuit. The frequency of the clock signal controls the switching speed or rate of the logic, and thus the timing performance of the circuit. There is a relationship between operating frequency and voltage level. An increase in operating frequency in a circuit increases performance of the circuit. However, an increase in operating frequency may also increase a minimum voltage level required to power the circuit for proper operation. Thus, an increase in operating frequency generally results in greater power consumption according to the dynamic power equation P=C V² f, where ‘P’ is power, ‘C’ is capacitance, ‘V’ is voltage, and ‘f’ is frequency. Thus, power consumption can be decreased by lowering the voltage level (‘V’) powering the circuit. However, a decrease in voltage decreases a maximum operating frequency possible for the circuit. The voltage level can be decreased until a minimum threshold voltage level for the circuit necessary for proper operation is reached.

Thus, when the operating frequency of a processing unit allows for a greater operating performance than is needed or required, the operating frequency can be scaled lower to, in turn, allow the operating voltage provided to the processing unit to be decreased. This reduces dynamic power consumption. If the CPU is in an idle state, the operating frequency and operating voltage can be scaled down to conserve power according to a frequency scaling algorithm. Even if the CPU is not in an idle state, if a CPU is under-utilized, the CPU may still be able to achieve a desired throughput with the operating performance and operating voltage scaled lower to conserve power. On the other hand, if a processing unit is over-utilized in an operating mode and can achieve greater performance by lowering utilization with an increase in operating frequency, the operating frequency can also be scaled up according to a scaling algorithm. The operating frequency could also be scaled up after other processing unit cores are first turned on in a multi-core processing unit system, if all processing cores are not in an active state.

Frequency scaling algorithms conventionally involve polling a processing unit for utilization over a period of time. In a scaling algorithm, the operating frequency can be scaled up if the processing unit is over-utilized. The operating frequency can be scaled down if the processing unit is under-utilized. Typically, the polling is implemented by creating an operating system (OS) soft- or real-time fixed poll timer (e.g., a ten (10) millisecond (ms) poll timer). A process or thread can determine processing unit utilization (referred to as “utilization polling thread”). The utilization polling process will not be scheduled for execution until the timer has expired. After the timer has expired, the OS will schedule the utilization polling process. Thereafter, when the utilization polling process is executed, the utilization polling process will gather the processing unit utilization time either from kernel data structures or from performance counters available in the processing unit. The scaling algorithm can then scale the operating frequency according to the determined processing unit utilization time.

A problem with polling a processing unit for utilization is that the frequency scaling decision is only made at fixed intervals of time. For example, assume that in the beginning of a particular ten (10) ms poll time, active processing units are fully utilized during the first few ms during the ten (10) ms time period. In this scenario, it would be expected and desired for the frequency scaling algorithm to scale up the operating frequency and/or turn on additional processing unit cores that were previously offline to share the processing load to reduce utilization of individual processing units. However, the utilization polling process will not get scheduled until the ten (10) ms poll timer expires, possibly after the spike in processing unit utilization has subsided. This results in reduced processing unit performance that may be noticeable by an end user of a processing unit device (e.g., in the form of audio glitches, video frame drops, user interface (UI) freezes, and/or delayed touch responses, etc.). Thus, polling for processing unit utilization may not allow timely responses to processing unit utilization spikes, thus reducing the performance of the processing unit as compared to what the performance could be if frequency scaling was performed more quickly in response to such utilization spikes.

To address quicker response times to processing unit utilization spikes, the expiration time of the poll timer could be reduced so that the utilization polling process, and in turn a frequency scaling algorithm, are executed more often to more quickly respond to processing unit utilization spikes. However, more frequent execution of a utilization polling process may cause other scheduled processes to be delayed in execution thereby reducing processing unit performance.

### SUMMARY OF THE DISCLOSURE

Aspects of the disclosure involve timer-based processing unit operational scaling employing timer resetting on idle process scheduling. In this regard, in one aspect, a timer is provided to control the scheduling of operational scaling of a processing unit. In one example, expiration of the timer triggers an interrupt controller to generate an interrupt to schedule a processing unit utilization process to be executed to scale operational performance, if the processing unit is not operating at a maximum operating frequency. To avoid the need for frequent generation of an interrupt that schedules execution of the processing unit utilization process, thereby taking away processing time from other active processes, the processing unit is configured to determine if an idle process is scheduled for execution before generating the interrupt. If the idle process is scheduled by the operating system (OS) of the processing unit, this is an inherent indication that the processing unit is not over-utilized, because otherwise, the idle process would not be scheduled. If the idle process is scheduled, the timer is reset before its expiration to avoid generating an interrupt that schedules execution of the processing unit utilization since operational scaling is not over-utilized. Thus, operational scaling is not required to reduce processing unit utilization. In this manner, the processing unit utilization process does not need to be executed, which would otherwise take away processing time from other active processes thus reducing processing unit performance as a result.

In this regard, in one aspect, a computer processing system is provided. The computer processing system comprises one or more CPUs each. The computer processing system also comprises at least one timer configured to generate a timer expired signal upon expiration of the at least one timer, and reset the at least one timer in response to receipt of at least one timer reset signal. The computer processing system also comprises an interrupt controller configured to generate a utilization interrupt in response to the timer expired signal. An active CPU among the one or more CPUs is configured to determine if an idle process is scheduled to be executed for the active CPU. In response to the idle process being scheduled to be executed by the active CPU, the active CPU is configured to cause the at least one timer reset signal to be generated to reset the at least one timer, and in response to the timer expired signal, generate the utilization interrupt to schedule a processing unit utilization process to be executed by the active CPU to determine a processing unit utilization of the active CPU.

In another exemplary aspect, a computer processing system is provided. The computer processing system comprises a means for determining if an idle process is scheduled to be executed by an active CPU among one or more CPUs. The computer processing system also comprises a means for resetting at least one means for providing a timer in response to the idle process being scheduled to be executed by the active CPU. The computer processing system also comprises a means for generating a timer expired signal upon expiration of the at least one means for providing the timer. The computer processing system also comprises a means for generating a utilization interrupt to schedule a processing unit utilization process to be executed by the active CPU in response to receiving the timer expired signal, to determine a processing unit utilization of the active CPU.

In another exemplary aspect, a method of frequency scaling a processing unit is provided. The method comprises determining if an idle process is scheduled to be executed by an active CPU among one or more CPUs. The method also comprises, in response to the idle process being scheduled to be executed by the active CPU, resetting at least one timer. The method also comprises, in response to the at least one timer expiring, generating a utilization interrupt to schedule a processing unit utilization process to be executed by the active CPU to scale an operational performance of the active CPU based on a determined processing unit utilization of the active CPU.

In another exemplary aspect, a non-transitory computer-readable medium having stored thereon computer executable instructions which, when executed by a processor, cause the processor to determine if an idle process is scheduled to be executed by an active CPU among one or more CPUs, in response to the idle process being scheduled to be executed by the active CPU, resetting at least one timer, and in response to the at least one timer expiring, generating a utilization interrupt to schedule a processing unit utilization process to be executed by the active CPU to scale an operational performance of the active CPU based on a determined processing unit utilization of the active CPU.

### BRIEF DESCRIPTION OF THE FIGURES

FIG. 1 is a block diagram of an exemplary processing unit that includes multiple processing cores, and a dynamic, timer-based operational scaling system employing timer resetting on idle process scheduling;

FIG. 2 is a flowchart illustrating an exemplary process of timer-based operational scaling of a central processing unit (CPU) in a processing unit employing timer resetting on idle process scheduling;

FIGS. 3A and 3B are flowcharts illustrating a more detailed exemplary process of timer-based operational scaling of a CPU in a processing unit employing timer resetting on idle process scheduling;

FIGS. 4A and 4B are flowcharts illustrating an exemplary process of timer-based operational scaling of CPUs in a multi-CPU processing unit employing timer resetting on idle process scheduling; and

FIG. 5 is a block diagram of an exemplary processor-based system that includes a processing unit employing a dynamic, timer-based operational scaling system employing timer resetting on idle process scheduling, to increase operational scaling response times with reduced impact on processing unit performance.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

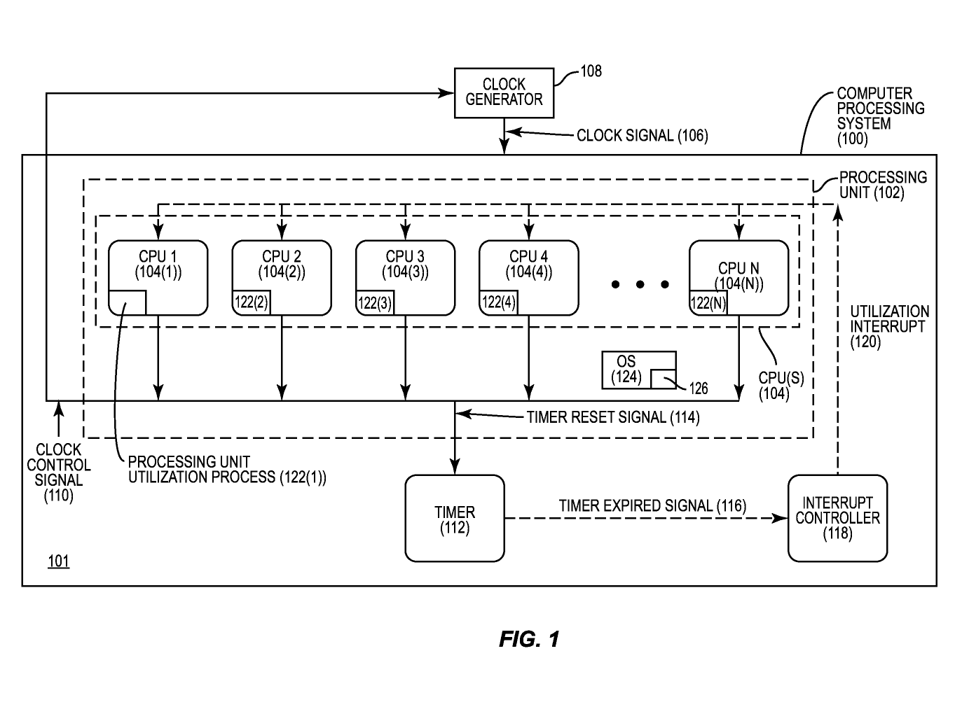

In this regard, FIG. 1 is a block diagram of an exemplary computer processing system 100. The computer processing system 100 could be provided in an integrated circuit (IC), such as a system-on-a-chip (SoC) 101. The computer processing system 100 includes a processing unit 102. The processing unit 102 includes one or more central processing units (CPUs) 104, shown in FIG. 1 as CPUs 104(1)-104(N). A CPU 104 may also be known or referred to as a processor core. One CPU 104 may be included in the processing unit 102 to provide a single CPU processing unit 102. The processing unit 102 may alternatively include a plurality of CPUs 104(1)-104(N) to provide a multiple-CPU processing unit 102. Thus, in a single CPU processing unit 102, ‘N’ in CPUs 104(1)-104(N) would be ‘1.’ For convenience, the below discussion of the processing unit 102 in the computer processing system 100 in FIG. 1 is initially discussed with regard to a CPU 104 as a single CPU processing unit 102. However, the discussion below of FIG. 1 regarding the single CPU 104 is also applicable to a multiple CPU 104(1)-104(N) processing unit 102.

With reference to FIG. 1, the CPU 104 is a synchronous circuit clocked by a clock signal 106 generated by a clock generator 108. The operating frequency of the CPUs 104 is based on the frequency of the clock signal 106. For example, the operating frequency of the CPU 104 may be the frequency of the clock signal 106 or may be derived from the clock signal 106, such as from a clock tree or clock divider circuit that receives the clock signal 106. As will be discussed in more detail below, the computer processing system 100 is configured to operationally scale the operating frequency of the CPU 104. The computer processing system 100 is configured to scale the operating frequency of the CPU 104 during active operation based on the utilization of the CPU 104. An active CPU 104 is a CPU 104 that is in an active state, actively executing instructions for a process or thread and is not in an idle, sleep, or power-down state. In this regard, operational scaling may be regarded as “dynamic” scaling. Examples of operational scaling of the CPU 104 include scaling the operating frequency of the CPU 104, and in the example of multiple CPUs 104(1)-104(N), activating one or more additional inactive (e.g., idle) CPUs 104(1)-104(N) to provide additional processing performance to lower CPU 104 utilization.

With continuing reference to FIG. 1, the performance of the CPU 104 is based on its operating frequency. The faster the operating frequency, the faster the rate of instruction execution (i.e., throughput) by the active CPU 104. Faster execution may lead to a lower CPU 104 utilization rate. Slower execution may lead to a higher CPU 104 utilization rate. Thus, it may be desired to increase or “scale up” the operating frequency of the CPU 104 during active periods until the utilization rate of the processing unit 102 is at a desired limit to achieve the desired performance of the processing unit 102 as one way to operationally scale performance. In this regard, the CPU 104 is configured to generate a clock control signal 110 to cause the clock generator 108 to adjust the frequency of the clock signal 106. In this manner as an example, the operating frequency of the CPU 104 can be increased, which can decrease CPU 104 utilization for improved performance. The operational performance of the CPU 104 can be scaled down by generating the clock control signal 110 to cause the clock generator 108 to decrease the frequency of the clock signal 106 if the processing unit 102 becomes under-utilized, to conserve power while still achieving the desired performance. In the case of multiple CPUs 104(1)-104(N), power can be conserved by not activating more CPUs 104(1)-104(N) than needed to achieve the desired processing unit 102 utilization rate. Also in the case of multiple CPUs 104(1)-104(N), if the processing unit 102 utilization rate is still beyond desired limits after maximizing the operating frequency of the CPU 104, other inactive CPUs 104(1)-104(N) in a sleep or idle state may be activated to lower the processing unit 102 utilization rate.

With continuing reference to FIG. 1, to determine the utilization of the CPU 104 to perform operational scaling, a timer 112 is provided in the computer processing system 100. The timer 112 may be a hardware timer as a non-limiting example. The timer 112 is reset by a timer reset signal 114 to begin a count according to the timer 112 configuration. Upon expiration, the timer 112 generates a timer expired signal 116 and provides the timer expired signal 116 to an interrupt controller 118. In this example, the timer expired signal 116 triggers the interrupt controller 118 to generate an interrupt 120, referred to here as a “utilization interrupt 120.” The utilization interrupt 120 generated as a result of the timer 112 expiration is communicated to the CPU 104 to a processing unit utilization process 122(1) to be executed in the CPU 104. In the case of multiple CPUs 104(1)-104(N), multiple processing unit utilization processes 122(1)-122(N) can be provided in each CPU 104(1)-104(N). With regard to CPU 104, the processing unit utilization process 122(1) includes an operational scaling operation configured to operationally scale the CPU 104 based on the utilization of the CPU 104. The processing unit utilization process 122(1) is configured to scale up or increase the operational performance of the CPU 104 if the CPU 104 is not operating at its maximum operational performance level. The processing unit utilization process 122(1) can include a frequency scaling operation based on the utilization of the CPU 104. Alternatively, in the example of multiple CPUs 104(1)-104(N) provided in the processing unit 102, the operating performance of the CPU 104 may not be scaled up until other non-active CPUs 104(1)-104(N) are first activated as a method to reduce CPU 104 utilization. In one example, the processing unit utilization process 122(1) may be a hardware thread that is scheduled by an operating system (OS) 124 to be executed by the respective CPUs 104(1)-104(N). The hardware thread will be executed by the CPUs 104(1)-104(N) based on software instructions 126 in the OS 124 to determine its CPU 104(1)-104(N) utilization.

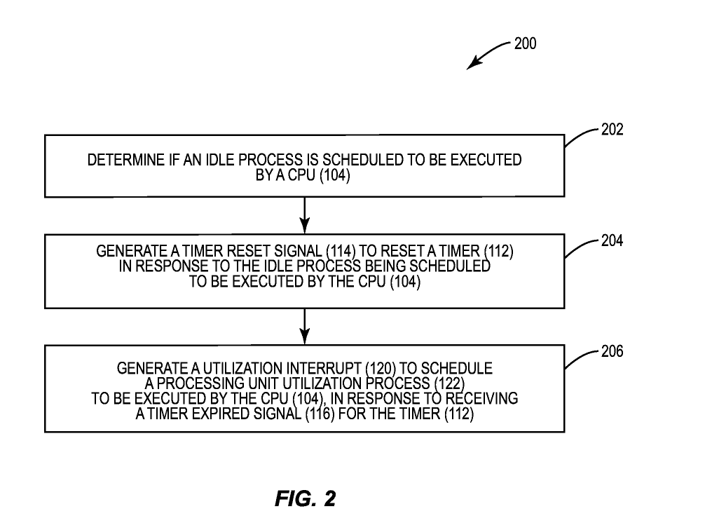

With continuing reference to FIG. 1, it may be desired to frequently execute the processing unit utilization process 122(1) in the CPU 104 to more quickly respond to utilization spikes. However, frequent generation of the utilization interrupt 120 that schedules execution of the processing unit utilization process 122(1) may take away processing time from other active processes being executed in the CPU 104. On the other hand, if the time interval between scheduling execution of the processing unit utilization process 122(1) is too large, utilization spikes in the CPU 104 may be missed. In this regard, in this example, a CPU 104 in FIG. 1 is configured to perform a process 200 in FIG. 2.

In this regard, with reference to FIGS. 1 and 2, a CPU 104 is configured to determine if an idle process is scheduled by the OS 124 for execution by the CPU 104 before expiration of the timer 112 (block 202 in FIG. 2). If the idle process was scheduled by the OS 124 for the CPU 104, this is an inherent indication that the CPU 104 is not over utilized, because otherwise, the idle process would not be scheduled for the CPU 104. Thus, if the idle process is scheduled for the CPU 104, no operational scaling is required, because the OS 124 in this example is designed to schedule the idle process only when other processes that could cause overutilization of the CPU 104 are not scheduled. Thus, the CPU 104 is configured to generate the timer reset signal 114 to reset the timer 112 in response to the idle process being scheduled to be executed by the CPU 104 (block 204 in FIG. 2). In this manner, the timer 112 does not expire based on its previous reset cycle. In turn, the interrupt controller 118 does not generate the utilization interrupt 120 to schedule execution of the respective processing unit utilization process 122 for the CPU 104, thus avoiding processing time from executing the processing unit utilization process 122 when the CPU 104 is known to not be over-utilized. This in turn may allow for the timer 112 to be configured to expire more frequently so that the processing unit utilization process 122 can be scheduled more frequently to be able to more quickly respond to processing spikes in the CPU 104. For example, the timer 112 may be configured to expire as quickly as one millisecond (ms) down to single timer tick of the timer 112, if desired, to more frequently schedule the processing unit utilization process 122 if an idle process is not scheduled for the CPU 104. The additional processing time incurred by more frequent scheduling of the processing unit utilization process 122 to be executed in the CPU 104 may be offset by the processing savings from not executing the processing unit utilization process 122 when idle periods are scheduled for the CPU 104.

However, with continuing reference to FIGS. 1 and 2, if it is determined that the idle process was not scheduled for the CPU 104 by the OS 124, this is an indication that the CPU 104 has processes to actively perform. In this manner, the timer 112 will be allowed to expire by the CPU 104, because the CPU 104 will not generate the timer reset signal 114 to reset the timer 112. Thus, the timer 112 will be allowed to expire, thereby generating the timer expired signal 116 upon the timer 112 expiring to the interrupt controller 118. In response, the interrupt controller 118 will generate the utilization interrupt 120 to cause the processing unit utilization process 122 to be scheduled to be executed by the CPU 104 (block 206 in FIG. 2). In response, the OS 124 will schedule the processing unit utilization process 122 as an interrupt service routine (ISR) to be executed by the CPU 104 in this example. As discussed above, the processing unit utilization process 122 will be executed by the CPU 104 to determine CPU 104 utilization, based on if it is determined if operational scaling should be performed. The execution of the processing unit utilization process 122 will consume processing power in the CPU 104, which may delay execution and completion of other active processes scheduled to be executed by the CPU 104. However, by the processing unit utilization process 122 only being scheduled to be executed by the CPU 104 when no idle process is scheduled, the processing unit utilization process 122 will not execute as often as it would if the processing unit utilization process 122 were scheduled without regard to whether an idle process was previously scheduled for execution by the CPU 104.

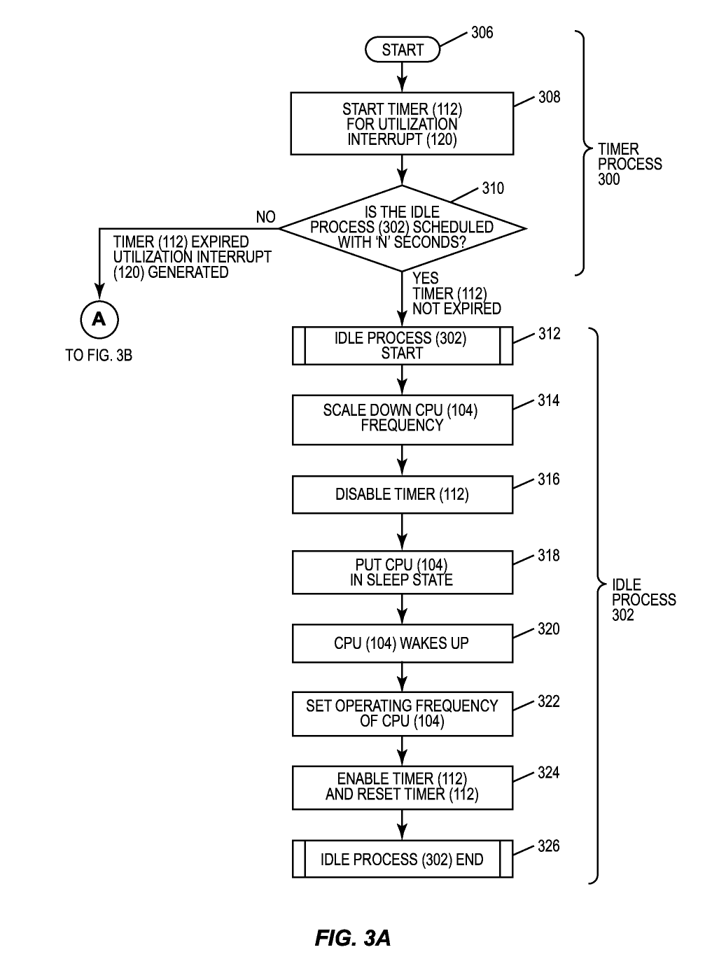

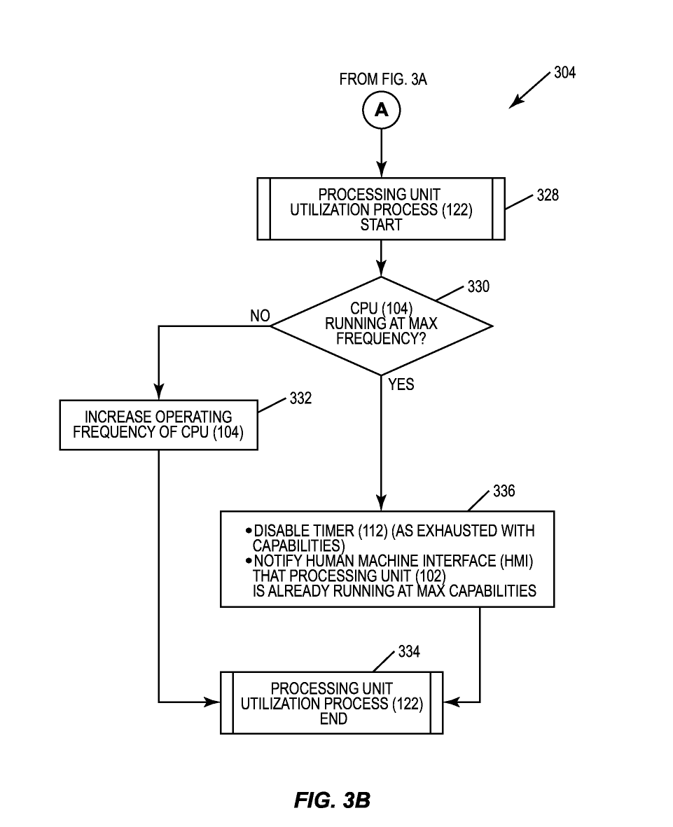

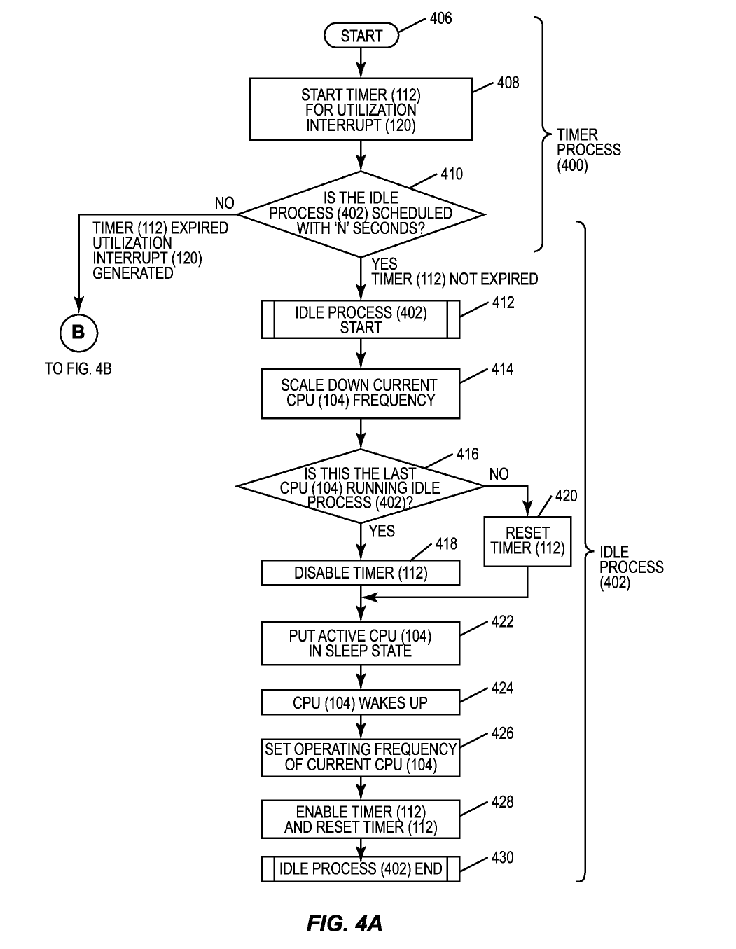

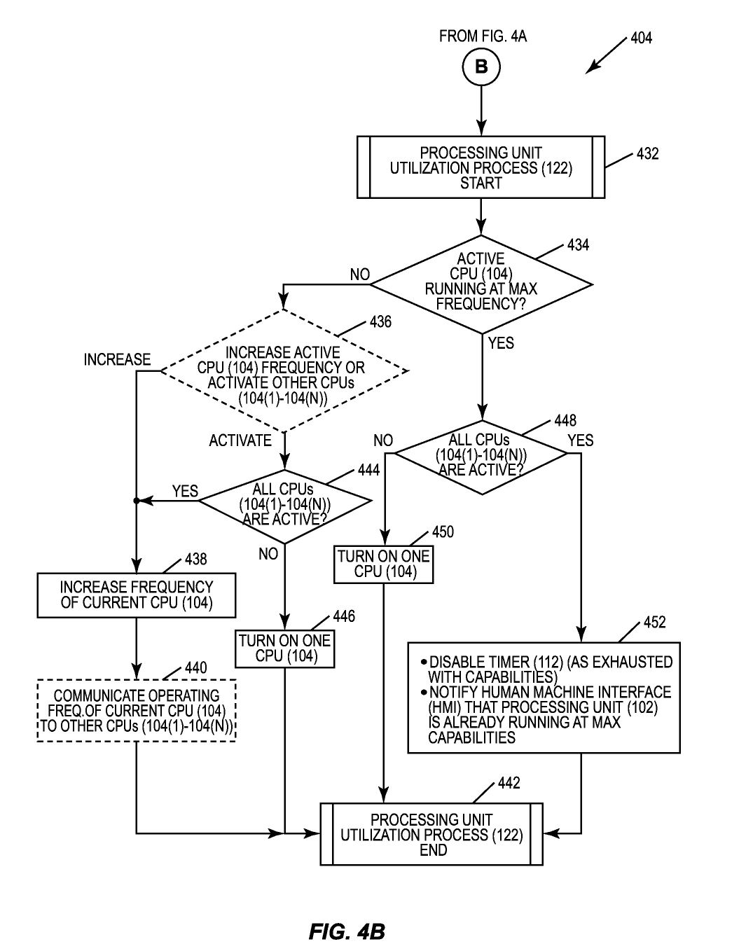

As discussed above, the computer processing system 100 in FIG. 1 includes the capability to operationally scale the performance of the processing unit 102. Also as discussed above, the processing unit 102 may include a single CPU 104 or multiple CPUs 104(1)-104(N). The flowcharts in FIGS. 3A and 3B described below provide more exemplary detail and options for the operation of the processing unit utilization process 122 and the idle process if the processing unit 102 includes a single CPU 104. The flowcharts in FIGS. 4A and 4B described below provide more exemplary detail and options for the operation of the processing unit utilization process 122 and the idle process if the processing unit 102 includes multiple CPUs 104(1)-104(N).

In this regard, FIG. 3A is a flowchart illustrating an exemplary timer process 300 of the timer 112 in FIG. 1 being reset and the processing unit 102 determining that an idle process is scheduled for execution by a CPU 104. If the idle process is scheduled for the CPU 104, FIG. 3A also illustrates an exemplary idle process 302 executed by a given CPU 104(1)-104(N). If the idle process 302 is not scheduled for a given CPU 104(1)-104(N), as discussed above, the timer 112 will eventually expire and the utilization interrupt 120 will be generated, in which case an ISR will be executed to schedule the processing unit utilization process 122 to be executed in the CPU 104. FIG. 3B illustrates an exemplary process 304 of the processing unit utilization process 122 for the CPU 104 being executed to perform operational scaling of the CPU 104.

In this regard, with reference to FIG. 3A, the timer process 300 starts (block 306). The timer reset signal 114 is generated by the processing unit 102 to start the timer 112 for the CPU 104 for causing the utilization interrupt 120 to be generated by the interrupt controller 118 if the timer 112 expires, as discussed above (block 308). For example, the timer 112 for the CPU 104 may be configured to expire every one (1) ms as a non-limiting example. Next, the processing unit 102 determines if an idle process 302 is scheduled to be executed for the CPU 104 within a predetermined amount of time (N seconds) (block 310). If the processing unit 102 determines in block 310 that the idle process 302 is not scheduled for the CPU 104, the timer 112 for the CPU 104 will be allowed to expire without being reset. This will cause the utilization interrupt 120 to cause the OS 124 to execute an ISR to schedule execution of the processing unit utilization process 122 for the CPU 104. Processing resumes in FIG. 3B.

With continuing reference to FIG. 3A, if the idle process 302 is scheduled to be executed by the OS 124 for the CPU 104, the CPU 104 is configured to execute the idle process 302 before the timer 112 expires. In this regard, the idle process 302 is executed in the CPU 104 by the OS 124 (block 312). The idle process 302 scales down the frequency of the clock signal 106 via the clock control signal 110 for the CPU 104, as an example, since the CPU 104 is going into an idle state as one way to operationally scale performance (block 314). The CPU 104 then causes its designated timer 112 to be disabled so that there are no system wake-ups of the CPU 104 when in the idle state (block 316).

With continuing reference to FIG. 3A, the idle process 302 next puts the CPU 104 to sleep in a low power idle state in this example (block 318). The CPU 104 will eventually wake-up from being in a sleep or idle state (block 320). After being awoken, the operating performance (e.g., operating frequency) of the CPU 104 is then set (block 322). As an example, the operating frequency of the active CPU 104 may be set to the previous operating frequency right before the CPU 104 went to sleep in block 318. The timer 112 is then enabled and reset (block 324). The idle process 302 is then completed in the CPU 104, and the idle process 302 ends for the CPU 104 (block 326).

In this regard, FIG. 3B illustrates the exemplary process 304 of the processing unit utilization process 122 for the CPU 104. The processing unit utilization process 122 starts (block 328) as a result of scheduling by the OS 124 in response to the ISR being executed in response to the utilization interrupt 120 generated by the interrupt controller 118. The CPU 104 determines if the CPU 104 is operating at its maximum operating frequency (block 330). If not, the CPU 104 causes the processing unit 102 to generate the clock control signal 110 to cause the clock generator 108 to increase the frequency of the clock signal 106 for the CPU 104 as one example of increasing operational performance (block 332). Thereafter, the processing unit utilization process 122 ends (block 334). The processing unit utilization process 122 will be scheduled and executed again if the timer 112 for the CPU 104 expires again, because the timer 112 was not reset.

With continuing reference to FIG. 3B, if the CPU 104 was operating at its maximum operating frequency (block 330), the CPU 104 causes the timer 112 to be disabled as the performance capabilities of the CPU 104 are exhausted as the CPU 104 is operating at its maximum operating frequency in this example (block 336). Thus, there is no reason for the timer 112 to be enabled while the CPU 104 is active and operating at its maximum operating performance since no further operational scaling (e.g., frequency scaling) can be performed to lower utilization of the processing unit 102. The OS 124 may also notify a human machine interface (HMI) (i.e., a display (e.g., a touch screen display) associated with the processing system 102) that the processing unit 102 is already running at maximum performance capability (block 336). Thereafter, the processing unit utilization process 122 ends (block 334). The processing unit utilization process 122 will be scheduled and executed again if the timer 112 for the CPU 104 expires again, because the timer 112 was not reset. As previously discussed above for the idle process 302 execution illustrated in FIG. 3A, once the CPU 104 goes idle, and the idle process 302 is executed, the timer 112 will be disabled (see block 316 in FIG. 3A).

As discussed above, the processing unit 102 in FIG. 1 may include multiple CPUs 104(1)-104(N) in the processing unit 102. If a CPU 104 is determined to be over-utilized, with multiple CPUs 104(1)-104(N), both operational scaling and/or activation of other inactive CPUs 104(1)-104(N) can be performed to reduce CPU 104 utilization and increase performance of the processing unit 102. If the processing unit 102 in FIG. 1 includes multiple CPUs 104(1)-104(N), the timer 112 may be provided as a single, shared timer 112 for each of the CPUs 104(1)-104(N) or as a private timer 112 dedicated to each CPU 104(1)-104(N). If a shared timer 112 is provided, the expiration of the shared timer 112 will control scheduling of execution of the processing unit utilization processes 122(1)-122(N) for the respective CPUs 104(1)-140(N). This is because each CPU 104(1)-104(N) will utilize the shared timer 112 in its timer process 300, idle process 302, and processing unit utilization process 122, which are described above with regard to FIGS. 3A and 3B. In this regard, when the timer 112 expires, and the interrupt controller 118 generates the utilization interrupt 120 in response, one or more of the active CPUs 104(1)-104(N) will receive the utilization interrupt 120. When a shared timer 112 is employed, the processing unit 102 is configured so that the first active CPU 104(1)-104(N) that receives the utilization interrupt 120 will clear the utilization interrupt 120 such that the processing unit utilization process 122 will not be scheduled for the other active CPUs 104(1)-104(N). The processing unit utilization process 122 that is scheduled for the CPU 104 will be executed to determine the CPU 104 utilization and scaling operational performance. If other CPUs 104(1)-104(N) that did not receive the utilization interrupt 120 may be operationally scaled based on the determined utilization by the processing unit utilization process 122 for the CPU 104 that responded to the utilization interrupt 120.

FIGS. 4A and 4B are flowcharts illustrating exemplary processes that can be executed by the CPUs 104(1)-104(N) in FIG. 1 in a multiple-CPU processing unit 102 to provide timer-based operational scaling employing timer resetting on idle process scheduling. Each CPU 104 that is active among the CPUs 104(1)-104(N) is configured to perform the processes 400, 402, 404 in FIGS. 4A and 4B. FIGS. 4A and 4B will be discussed in reference to the computer processing system 100 in FIG. 1.

In this regard, FIG. 4A is a flowchart illustrating an exemplary timer process 400 of the timer 112 in FIG. 1 being reset and the processing unit 102 determining that an idle process 402 is scheduled for execution by a CPU 104(1)-104(N). As discussed above, the timer 112 that is reset may be a shared timer 112 shared between all CPUs 104(1)-104(N), or may be a private timer 112 dedicated to a particular respective CPU 104(1)-104(N). If the idle process 402 is scheduled for a given CPU 104(1)-104(N), FIG. 4A also illustrates the exemplary idle process 402 executed by the given CPU 104(1)-104(N). If the idle process 402 is not scheduled for a given CPU 104(1)-104(N), as discussed above, the timer 112 (whether shared for all CPUs 104(1)-104(N) or dedicated to a particular CPU 104(1)-104(N)) will eventually expire and the utilization interrupt 120 will be generated, in which case an ISR will be executed to schedule the processing unit utilization processes 122(1)-122(N) to be executed in the respective CPU 104(1)-104(N). FIG. 4B illustrates an exemplary process 404 of the processing unit utilization processes 122(1)-122(N) for a given CPU 104(1)-104(N) being executed to perform operational scaling of the respective CPU 104(1)-104(N).

In this regard, with reference to FIG. 4A, the timer process 400 starts (block 406). The timer reset signal 114 is generated by the processing unit 102 to start the timer 112 for the active CPU 104 for causing the utilization interrupt 120 to be generated by the interrupt controller 118 if the timer 112 expires, as discussed above (block 408). For example, the timer 112 for the active CPU 104 may be configured to expire every one (1) ms as a non-limiting example. Next, the processing unit 102 determines if an idle process 402 is scheduled to be executed for a given CPU 104(1)-104(N) within a predetermined amount of time (N seconds) (block 410).

With continuing reference to FIG. 4A, if an idle process 402 is scheduled to be executed by the OS 124 for a given CPU 104(1)-104(N), the idle process 402 is eventually executed by the CPU 104(1)-104(N) before the timer 112 for the given CPU 104(1)-104(N) expires. In this regard, the idle process 402 is scheduled to be executed in the CPU 104(1)-104(N) by the OS 124. The idle process 402 is then executed by a given, active CPU 104 (block 412). The idle process 402 scales down the frequency of the clock signal 106 via the clock control signal 110 for the active CPU 104 since the active CPU 104 is going into an idle state as one way to operationally scale performance (block 414). The active CPU 104 then determines if the active CPU 104 is the last active CPU 104 among the CPUs 104(1)-104(N) in the processing unit 102 that is executing an idle process 402 (block 416). If all other CPUs 104(1)-104(N) are in an idle state, the active CPU 104 causes the timer 112 for the active CPU 104 to be disabled so that there are no system wake-ups based on the timer 112 expiring when all CPUs 104(1)-104(N) are in the idle state (block 418). Otherwise, the active CPU 104 causes the timer reset signal 114 to be generated to reset the timer 112 for the active CPU 104, since there is at least one other CPU 104(1)-104(N) in the processing unit 102 that is active, and so that the timer 112 will not expire and trigger the generation of the utilization interrupt 120 (block 420).

With continuing reference to FIG. 4A, the idle process 402 next puts the active CPU 104 to sleep in a low power idle state in this example (block 422). The active CPU 104 will eventually wake-up from being in a sleep or idle state (block 424). The operating frequency of the active CPU 104 that is awoken is set by the active CPU 104 (block 426). As an example, the operating frequency of the active CPU 104 may be set to the previous operating frequency right before the CPU 104 went to sleep in block 422. Or alternatively, as another option, the operating frequency of the active CPU 104 may be synchronized to the operating frequency of the other active CPUs 104(1)-104(N) in the processing unit 102. The timer 112 for the active CPU 104 is then enabled and reset (block 428). As discussed above, if the timer 112 is a shared timer 112, the processing unit 102 is configured so that the first active CPU 104(1)-104(N) that receives the utilization interrupt 120 will clear the utilization interrupt 120 such that the processing unit utilization process 122 will not be scheduled for the other active CPUs 104(1)-104(N). The idle process 402 is then completed in the active CPU 104, and the idle process 402 ends for the active CPU 104 (block 430). Because the timer 112 is reset, if the processing unit 102 determines in block 410 that the idle process 402 is not scheduled for a respective CPU 104(1)-104(N), the timer 112 for the active CPU 104 will be allowed to expire without being reset. This will cause the utilization interrupt 120 to cause the OS 124 to execute an ISR to schedule execution of the processing unit utilization processes 122(1)-122(N) for the respective CPUs 104(1)-104(N). Processing then resumes in FIG. 4B.

In this regard, FIG. 4B illustrates the exemplary process 404 of the processing unit utilization process 122 for an active CPU 104. The processing unit utilization process 122 starts (block 432) as a result of scheduling by the OS 124 in response to the ISR being executed in response to the utilization interrupt 120 generated by the interrupt controller 118. The active CPU 104 determines if the active CPU 104 in the processing unit 102 is operating at its maximum operating frequency (block 434). If not, the active CPU 104 determines if the operating frequency should be increased or other inactive CPUs 104(1)-104(N) should be activated to reduce the utilization of the active CPU 104 (block 436). If the operating frequency of the active CPU 104 is to be increased, the active CPU 104 causes the processing unit 102 to generate the clock control signal 110 to cause the clock generator 108 to increase the frequency of the clock signal 106 for the active CPU 104 (block 438). This frequency scaling may involve optionally increasing and/or synchronizing the operating frequency of any one or all of the active CPUs 104(1)-104(N). Thus, performance is increased while the active CPU 104 active. The CPU 104 may optionally communicate its new operating frequency to the other active CPUs 104(1)-104(N) in the case that the other active CPUs 104(1)-104(N) are configured to change their operating frequency to the operating frequency of the scaled, active CPU 104 (block 440). Thereafter, the processing unit utilization process 122 ends (block 442). The processing unit utilization process 122 will be scheduled and executed again if the timer 112 for the active CPU 104 expires again, because the timer 112 was not reset.

With continuing reference to FIG. 4B, if the active CPU 104 determines that inactive CPUs 104(1)-104(N) should be activated first to reduce the utilization of the active CPU 104 (block 436), the active CPU 104 determines if all other CPUs 104(1)-104(N) are active (block 444). If other CPUs 104(1)-104(N) are active (block 444), the active CPU 104 increases its operating frequency (block 438) as discussed above. However, if all other CPUs 104(1)-104(N) are not active, the active CPU 104 causes the OS 124 to turns on an additional CPU 104 among the inactive CPUs 104(1)-104(N) to provide greater operational capacity and to lower the active CPU 104 utilization as another manner of performing operational scaling (block 446). Thereafter, the processing unit utilization process 122 ends (block 442). Again, the processing unit utilization process 122 will be scheduled and executed again if the timer 112 for the active CPU 104 expires again, because the timer 112 was not reset.

With continuing reference to FIG. 4B, if the active CPU 104 was operating at its maximum operating frequency (block 434), the active CPU 104 determines if all CPUs 104(1)-104(N) are active (block 448). If not, the active CPU 104 causes the OS 124 to activate an additional CPU 104 to provide greater operational capacity and to lower CPU 104 utilization if there is at least one CPU 104(1)-104(N) that is inactive/in sleep mode as another manner of performing operational scaling (block 450). Thereafter, the processing unit utilization process 122 ends (block 442). If, however, all CPUs 104(1)-104(N) were active (block 448), the CPU 104 causes the timer 112 for the active CPU 104 to be disabled as the performance capabilities of the processing unit 102 are exhausted as all CPUs 104(1)-104(N) are active and operating at their maximum operating frequency (block 452). Thus, there is no reason for the timer 112 to be enabled while all CPUs 104(1)-104(N) are active and operating at their maximum operating frequency since no further operational scaling (e.g., frequency scaling and/or activation of other CPUs 104(1)-104(N)) can be performed to lower utilization of the processing unit 102. The OS 124 may notify the HMI that the processing unit 102 is already running at maximum performance capability (block 452). Thereafter, the processing unit utilization process 122 ends (block 442). The processing unit utilization process 122 will be scheduled and executed again if the timer 112 for the active CPU 104 expires again, because the timer 112 was not reset. As previously discussed above for the idle process 402 execution illustrated in FIG. 4A, once a CPU 104 goes idle, and the idle process 402 is executed, the timer 112 will be reset (see block 420 in FIG. 4A).

A processing unit that employs timer-based operational scaling employing timer resetting on idle process scheduling, according to aspects disclosed herein, may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

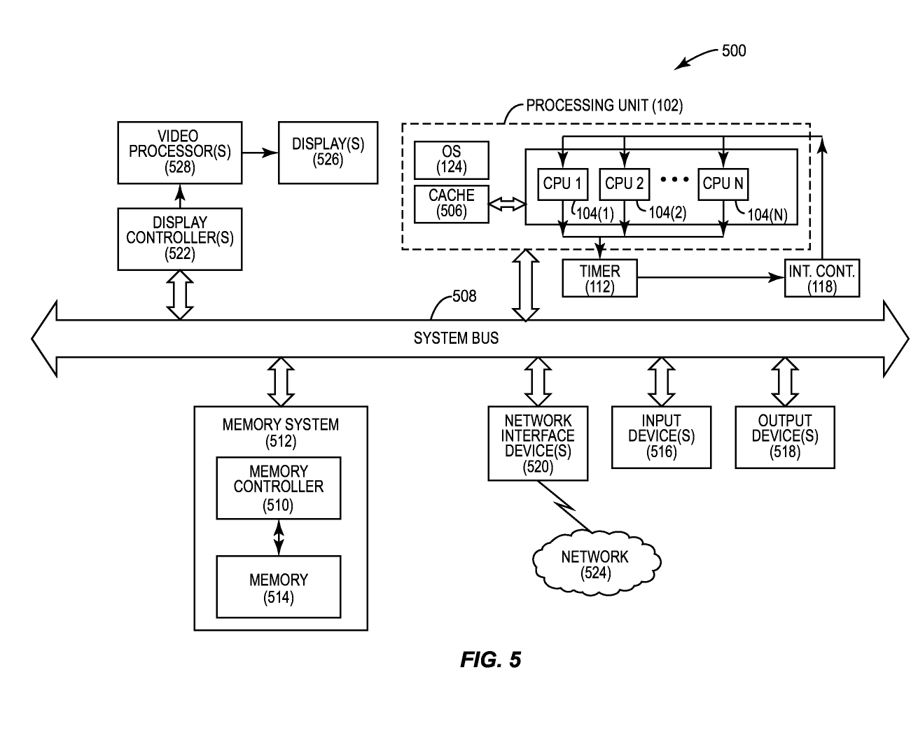

In this regard, FIG. 5 illustrates an example of a processor-based system 500 that can employ dynamic, timer-based operational scaling systems employing timer resetting on idle process scheduling, according to any of the particular aspects discussed above. In this example, the processor-based system 500 includes the processing unit 102 in FIG. 1 that includes the one or more CPUs 104(1)-104(N), also known as processors. The processing unit 102 is configured to reset a timer on idle process scheduling for one or more of the CPUs 104(1)-104(N) to increase operational scaling response times with reduced impact on processing unit performance according to aspects disclosed herein. The processing unit 102 may also include a cache memory 506 coupled to the CPU(s) 104(1)-104(N) for rapid access to temporarily stored data. The processing unit 102 is coupled to a system bus 508 and can intercouple peripheral devices included in the processor-based system 500. As is well known, the processing unit 102 communicates with these other devices by exchanging address, control, and data information over the system bus 508. For example, the processing unit 102 can communicate bus transaction requests to a memory controller 510 in a memory system 512 as an example of a slave device. Although not illustrated in FIG. 5, multiple system buses 508 could be provided, wherein each system bus 508 constitutes a different fabric. In this example, the memory controller 510 is configured to provide memory access requests to memory 514 in the memory system 512.

Other devices can be connected to the system bus 508. As illustrated in FIG. 5, these devices can include the memory system 512, one or more input devices 516, one or more output devices 518, one or more network interface devices 520, and one or more display controllers 522, as examples. The input device(s) 516 can include any type of input device, including but not limited to input keys, switches, voice processors, etc. The output device(s) 518 can include any type of output device, including but not limited to audio, video, other visual indicators, etc. The network interface device(s) 520 can be any devices configured to allow exchange of data to and from a network 524. The network 524 can be any type of network, including but not limited to a wired or wireless network, a private or public network, a local area network (LAN), a wireless local area network (WLAN), a wide area network (WAN), a BLUETOOTH™ network, and the Internet. The network interface device(s) 520 can be configured to support any type of communications protocol desired.

The processing unit 102 may also be configured to access the display controller(s) 522 over the system bus 508 to control information sent to one or more displays 526. The display controller(s) 522 sends information to the display(s) 526 to be displayed via one or more video processors 528, which process the information to be displayed into a format suitable for the display(s) 526. The display(s) 526 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A computer processing system, comprising:
one or more central processing units (CPUs);
at least one timer configured to generate a timer expired signal upon expiration of the at least one timer, and reset the at least one timer in response to receipt of at least one timer reset signal; and
an interrupt controller configured to generate a utilization interrupt in response to the timer expired signal;
wherein an active CPU among the one or more CPUs is configured to:
determine if an idle process is scheduled to be executed for the active CPU;
in response to the idle process being scheduled to be executed by the active CPU, cause the at least one timer reset signal to be generated to reset the at least one timer; and
in response to the timer expired signal, generate the utilization interrupt to schedule a processing unit utilization process to be executed by the active CPU to determine a processing unit utilization of the active CPU.

2. The computer processing system of claim 1, wherein the active CPU is configured to execute the processing unit utilization process to scale an operational performance of the active CPU based on the determined processing unit utilization of the active CPU.

3. The computer processing system of claim 2, wherein the active CPU is configured to scale the operational performance of the active CPU by being configured to increase an operating frequency of the active CPU based on the determined processing unit utilization of the active CPU.

4. The computer processing system of claim 1, wherein the active CPU is further configured to execute the processing unit utilization process to determine if the active CPU is operating at a maximum operating frequency for the active CPU.

5. The computer processing system of claim 4, wherein the active CPU is further configured to request an increase in an operating frequency of the active CPU if the active CPU is determined to not be operating at the maximum operating frequency.

6. The computer processing system of claim 1, wherein the active CPU is further configured to disable the at least one timer if the active CPU is determined to be operating at a maximum operating frequency.

7. The computer processing system of claim 1, wherein the active CPU is further configured to execute a scheduled idle process in an idle state to scale down an operating frequency of the active CPU.

8. The computer processing system of claim 7, wherein the active CPU is further configured to execute the scheduled idle process to cause the at least one timer reset signal to be generated to reset the at least one timer.

9. The computer processing system of claim 8, wherein the active CPU is further configured to execute the scheduled idle process to cause an enable of the at least one timer after the active CPU wakes up.

10. The computer processing system of claim 1, wherein the one or more CPUs comprise a plurality of CPUs each configured as an active CPU to:
determine if the idle process is scheduled to be executed for the active CPU;
in response to the idle process being scheduled to be executed by the active CPU, cause the at least one timer reset signal to be generated to reset the at least one timer;
in response to the timer expired signal, generate the utilization interrupt to schedule the processing unit utilization process to be executed by the active CPU to determine the processing unit utilization of the active CPU; and
scale an operational performance of the active CPU based on the determined processing unit utilization of the active CPU.

11. The computer processing system of claim 10, wherein the active CPU is further configured to execute the processing unit utilization process to:
determine if the active CPU is operating at a maximum operating frequency for the active CPU;
determine if all other CPUs among the plurality of CPUs are active if the active CPU is determined to not be operating at the maximum operating frequency; and
activate at least one other CPU among the plurality of CPUs if the active CPU is determined to not be operating at the maximum operating frequency and all other CPUs among the plurality of CPUs are active if the active CPU is determined to not be operating at the maximum operating frequency.

12. The computer processing system of claim 10, wherein the active CPU is further configured to execute the processing unit utilization process to increase an operating frequency of the active CPU if all other CPUs among the plurality of CPUs are active and if the active CPU is determined to not be operating at the maximum operating frequency.

13. The computer processing system of claim 10, wherein the active CPU is further configured to execute the processing unit utilization process to communicate a scale in the operational performance of the active CPU based on the determined processing unit utilization of the active CPU, to all other CPUs among the plurality of CPUs.

14. The computer processing system of claim 10, wherein the active CPU is further configured to:
receive the operational performance of another CPU among the plurality of CPUs; and
scale the operational performance of the active CPU based on the received operational performance of the another CPU among the plurality of CPUs.

15. The computer processing system of claim 10, wherein the active CPU is further configured to execute a scheduled idle process in an idle state to cause the at least one timer reset signal to be generated to reset the at least one timer if the active CPU is not an only CPU among the plurality of CPUs executing the idle process.

16. The computer processing system of claim 10, wherein the active CPU is further configured to execute a scheduled idle process in an idle state to cause the at least one timer to be disabled if the active CPU is an only CPU among the plurality of CPUs executing the idle process.

17. The computer processing system of claim 1, wherein the at least one timer is comprised of at least one hardware timer.

18. The computer processing system of claim 1, wherein the at least one timer is configured to generate the timer expired signal after each timer tick of the at least one timer.

19. The computer processing system of claim 10, wherein the at least one timer is comprised of a shared timer.

20. The computer processing system of claim 10, wherein the at least one timer is comprised of a plurality of private timers, each of the plurality of private timers dedicated to a CPU among the plurality of CPUs;
each of the plurality of private timers configured to generate the timer expired signal upon expiration of the private timer, and reset the private timer in response to receipt of a dedicated timer reset signal;
the active CPU configured to:
in response to the idle process being scheduled to be executed by the active CPU, cause the at least one timer reset signal to be generated to reset the private timer dedicated to the active CPU; and
in response to the at least one timer expired signal from the private timer dedicated to the active CPU, generate the utilization interrupt to schedule the processing unit utilization process to be executed by the active CPU to determine the processing unit utilization of the active CPU.

21. The computer processing system of claim 1 integrated into a system-on-a-chip (SoC).

22. The computer processing system of claim 1 integrated into a device selected from the group consisting of: a set top box; an entertainment unit; a navigation device; a communications device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

23. A computer processing system, comprising:
a means for determining if an idle process is scheduled to be executed by an active central processing unit (CPU) among one or more CPUs;
a means for resetting at least one means for providing a timer in response to the idle process being scheduled to be executed by the active CPU;
a means for generating a timer expired signal upon expiration of the at least one means for providing the timer; and
a means for generating a utilization interrupt to schedule a processing unit utilization process to be executed by the active CPU in response to receiving the timer expired signal, to determine a processing unit utilization of the active CPU.

24. A method of frequency scaling a processing unit, comprising:
determining if an idle process is scheduled to be executed by an active central processing unit (CPU) among one or more CPUs;
in response to the idle process being scheduled to be executed by the active CPU, resetting at least one timer; and
in response to the at least one timer expiring, generating a utilization interrupt to schedule a processing unit utilization process to be executed by the active CPU to scale an operational performance of the active CPU based on a determined processing unit utilization of the active CPU.

25. The method of claim 24, further comprising:
determining if the active CPU is operating at a maximum operating frequency for the active CPU; and
requesting an increase in an operating frequency of the active CPU if the active CPU is determined to not be operating at the maximum operating frequency.

26. The method of claim 24, further comprising:
determining if the active CPU is operating at a maximum operating frequency for the active CPU; and
disabling the at least one timer if the active CPU is determined to be operating at the maximum operating frequency.

27. The method of claim 24, wherein the one or more CPUs comprise a plurality of CPUs, each CPU among the plurality of CPUs as the active CPU:
determining if the idle process is scheduled to be executed by the active CPU among the one or more CPUs;
in response to the idle process being scheduled to be executed by the active CPU, resetting the at least one timer; and
in response to the at least one timer expiring, generating the utilization interrupt to schedule the processing unit utilization process to be executed by the active CPU to scale the operational performance of the active CPU based on the determined processing unit utilization of the active CPU.

28. The method of claim 27, wherein the active CPU is further configured to execute the processing unit utilization process to:
determine if the active CPU is operating at a maximum operating frequency for the active CPU;
determine if all other CPUs among the plurality of CPUs are active if the active CPU is determined to not be operating at the maximum operating frequency; and
activate at least one other CPU among the plurality of CPUs if the active CPU is determined to not be operating at the maximum operating frequency and all other CPUs among the plurality of CPUs are active if the active CPU is determined to not be operating at the maximum operating frequency.

29. The method of claim 27, wherein the active CPU is further configured to execute the processing unit utilization process to communicate a scale in the operational performance of the active CPU based on the determined processing unit utilization of the active CPU, to all other CPUs among the plurality of CPUs.

30. A non-transitory computer-readable medium having stored thereon computer executable instructions which, when executed by a processor, cause the processor to:
determine if an idle process is scheduled to be executed by an active central processing unit (CPU) among one or more CPUs;
in response to the idle process being scheduled to be executed by the active CPU, resetting at least one timer; and
in response to the at least one timer expiring, generating a utilization interrupt to schedule a processing unit utilization process to be executed by the active CPU to scale an operational performance of the active CPU based on a determined processing unit utilization of the active CPU.
